(19) United States
(12) Patent Application Publication
(10) Pub. No.: US 2003/0144038 A1
(43) Pub. Date: Jul. 31, 2003

(54) Automatic transmission of an information reply signal

(76) Inventor: Pierluigi Pugliese, (US)

Correspondence Address: Docket Administrator, Agere Systems Inc., Room 4U-533C, 4 Connell Drive, Berkeley Heights, NJ, 07922-2747, US

(21) Appl. No.: 10/349,866

(22) Filed: Jan. 23, 2003

(30) Foreign Application Priority Data
Jan. 29, 2002 (EP) 020002165.5

(51) Int. Cl. H04M 3/42; H04M 1/00; H04B 1/38

(52) U.S. Cl. 455/567; 455/575; 455/414

(57) ABSTRACT

The invention relates to the situation, if a party of a telecommunication system, in particular of a mobile radio system, is calling another party of the same or even of another telecommunication system and the called party is not available. An object of the invention is therefore to provide a new and improved approach for directing an information reply to the calling party if the called party is missing the call or is not available. Accordingly, the invention proposes a method and a user terminal (20) for automatically transmitting an information reply signal (Sᵣ) between the user terminal (20) of a called party of a telecommunication system, in particular of a mobile radio telecommunication system, and the user terminal (10) of a calling party of a telecommunication system, in particular of a mobile radio telecommunication system, wherein the information reply signal (Sᵣ) is transmitted from the user terminal (20) of the called party to the user terminal (10) of the calling party in response to an incoming call (Sᵢ) originated by said calling party.

### TECHNICAL FIELD OF THE INVENTION

The invention relates to a method for transmitting an information reply signal between the user terminal of a called party and the user terminal of a calling party of at least one telecommunication system and to a user terminal having such functionality.

### BACKGROUND OF THE INVENTION

Usually, if a party of a telecommunication system, in particular of a mobile radio system, is calling another party of the same or even of another telecommunication system and the called party for example is not available, this called party usually is missing that call. In this situation the called party might want to inform the calling party that he is reachable also on some other number or might want to transmit the calling party some other information that the calling party might use.

A known possibility to inform the calling party in such a situation accordingly, is to redirect a voice mail, such as for example by use of a telephone answerer or by use of a mail box. However, for the redirection of a voice mail normally the normal rate for a call is charged dependent on the respective telecommunication systems to the calling party or to the called party.

Moreover, usually such a telephone answerer or mail box is apt to redirect merely one or two voice mails independent on who is the calling party and independent on any other circumstances, such as for example the day time.

Additionally, the telephone answerer usually is a separate device which has to be bought resulting in additional costs, whereas a mail box is a service supported by the operator of the respective telecommunication system but for which the customer has to pay a rental.

### SUMMARY OF THE INVENTION

An object of the invention is therefore to provide with regard to the above mentioned prior art a new and improved approach for redirecting a reply to the calling party if the called party is missing the call or is not available.

Accordingly, the invention proposes to automatically retransmit an information signal from the user terminal of the called party to the user terminal of the calling party in response to an incoming call of said called party, with the incoming call originated by said calling party. Thus, in particular by use of a user terminal having means for directly transmitting or re-transmitting an information signal to a user terminal in response to an incoming call originated by said latter user terminal, there is not a need for any further additional and/or separate answering device or answering service and hence, the inventive approach significantly reduces the cost of purchase or the monthly running costs.

According to preferred embodiments it is proposed to generate such an information signal for optically and/or acoustically replaying. However, according to a very preferred refinement the inventive user terminal is provided with means for generating the information signal by use of a so called short message service which can be transmitted in comparison to an ordinary voice mail more cheaper.

Practically, the user terminal is provided with means for individually generating and storing at least one of such a re-transmittable information signal significantly improving the flexibility of the specific reply-messages.

Furthermore, the invention proposes to provide the inventive user terminal with means for assigning the at least one generated and stored information signal to at least one definable phone number of potential calling parties enabling that the messages might be different for each caller whereby also a grouping mechanism might be used, such as for example assigning one message to a plurality of potential calling parties.

Moreover, it is suggested to further provide means for assigning the at least one information signal to at least one specific day time such that the reply message might be different for each time of the day and thus can be optimised according to the individual behaviour of the called party.

According to a further improvement, the inventive user terminal comprises means for optionally activating the means for transmitting the information reply signal, whereby said means for activating preferably comprises a threshold with regard to the amount of call signals or ringing tones necessary for activating the means for transmitting.

Preferably, the inventive user terminal is incorporating a microprocessor or digital signal processor for supporting the inventive method and/or can be adapted accordingly by implementing a corresponding software further improving the flexibility of the automatic re-transmitting of individual information reply signals.

The invention also is covering a telecommunication system comprising such inventive user terminal and the respective implementation program product adapted to perform the inventive method.

### BRIEF DESCRIPTION OF THE DRAWINGS

Subsequently, the invention is exemplary described in more detail, in particular on the basis of a preferred refinement and with reference to the accompanied drawing, in which:

FIG. 1 is schematically depicting the principle of transmitting or re-transmitting an information reply signal directly between two user terminals according to the invention, and

FIG. 2 is schematically depicting essential components according to a very preferred embodiment of the inventive user terminal.

### DETAILED DESCRIPTION

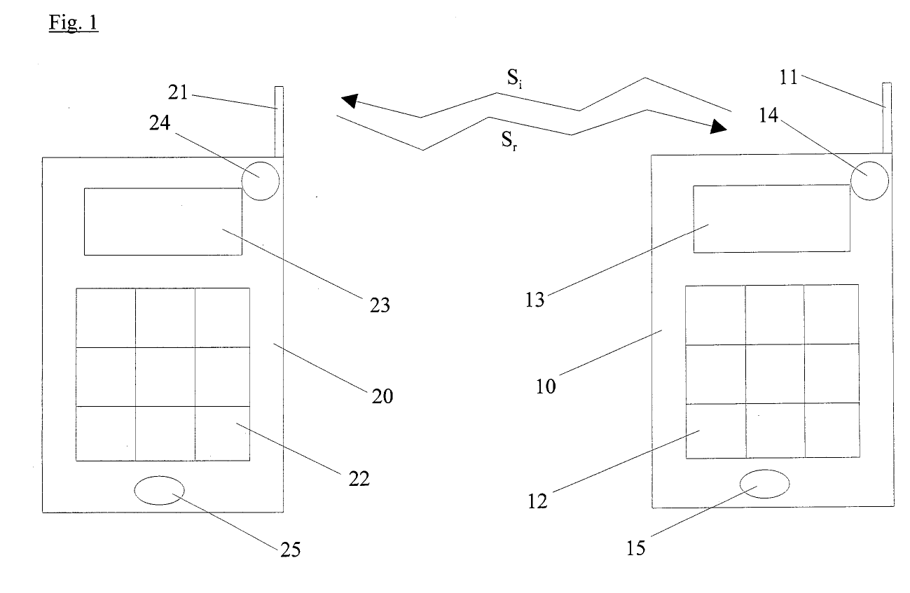

Referring next to FIG. 1, two user terminals 10 and 20 are schematically depicted, wherein the user terminal 10 is classified as a mobile station of a calling party of a mobile radio telecommunication system and the user terminal 20 is classified as a mobile station of a called party also of a mobile radio telecommunication system that can be identical to the previous system or can be another system.

Each of the user terminals are provided with an antenna 11, 21 adapted to transmit and receive information signals Sᵢ, Sᵣ, with a key board 12, 22 for controlling the specific operating functions and a display 13, 23 for optically representing selected operating functions, incoming or originating calls, stored parties assigned to their respective telephone number or for optically representing further services. Additionally each of the user terminals 10 and 20 is comprising a loudspeaker 14, 24 and a microphone 15, 25.

The information signal Sᵢ is representing an incoming call with regard to the user terminal 20 that is originated by the user terminal 10. On condition that the called party is not available or is simply missing the incoming call Sᵢ or does not want to accept the incoming call Sᵢ, for example due to the specific calling party optically depicted on the display 23, the user terminal 20 is automatically directed to send the originating user terminal 10 an information reply-signal Sᵣ preferably by use of an stored text message using a so-called short message service (SMS) supported by a plurality of telecommunication systems. Typical examples for such a text message may be “please try to call me at . . . ”, “I will be available in a few minutes”, “sorry, try tomorrow”.

As known by persons skilled in the art such an SMS may be transmitted simultaneously but parallel to the incoming call Sᵢ or after the call Sᵢ has been terminated due to the non-acceptation thereof by the called party.

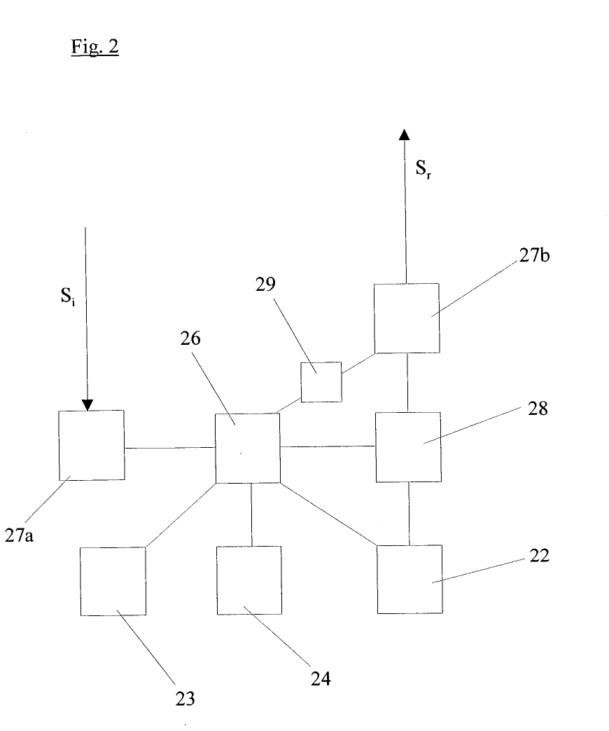

Essential components of the user terminal 20 for an exemplar methodology for such an automatic direction is schematically depicted in FIG. 2.

Accordingly, an incoming call Sᵢ passing the antenna is fed to a receiving unit 27a for the respective telecommunication system specific call signal processing. The receiving unit 27a is connected to a central micro processor 26 which is connected to the speaker unit 24 and to the display 23 to provide the call or ringing signal for the incoming call Sᵢ or to display for example the call number of the calling party.

The central micro processor 26 further is connected to the key board 22, a storage unit 28 and via a timer unit 29 to a transmitting unit 27b.

For controlling the generating of an automatic transmittable reply signal Sᵣ the micro processor 26 may comprise a corresponding hardware and/or software implementation, wherein the latter practically improves the flexibility. The storage unit 28 is further connected with the key board 22 so that individually generated or created messages and/or customised by the customer at will by use of the key board 22 can be stored in the storage unit 28.

Moreover, the exemplary arrangement of FIG. 2 incorporated in the user terminal 20 of FIG. 1 and especially the micro processor 26 is adapted such that a plurality of messages can be generated and stored, whereby each of the respective messages can be assigned to the telephone or call number of a specific party which also is stored in the storage unit 28.

Additionally, for assigning a message to a call or telephone number any grouping mechanism might be used, such as for example for assigning a plurality of messages to one stored telephone number and/or for assigning one message to a plurality of stored telephone numbers. Moreover, each of the messages may be assigned to a specific day time, for example the message “I should be reachable in the office now” may be assigned to the working time of the individual customer. For the evening for example a message like “hey, I am likely to have a dinner now, try at home” may be created.

If an incoming call Sᵢ is received at the receiver unit 27a and practically the speaker unit 24 is providing the call signal, the microprocessor 26 is searching for a transmittable message stored in the storage unit 28 that is assigned to the number of the calling party if said calling party is stored or for a message that is assigned to the actual time of the day. If there is no message complying with at least one of these conditions, or if the number of the called party is not stored a general message or a message depending on chance is selected of fetched from the storage 28 that has to be transmitted to the calling party via the transmitting unit 27b processing the respective information signal to be fed to the antenna for transmission.

The exemplar mobile station 20 is further comprising a timer unit or threshold unit 29 to determine, practically also by use of the key board 22 a delay time for transmitting the reply signal Sᵣ with regard to the time of the incoming call Sᵢ. This can be provided for example by use of a threshold representing a time duration, in particular a definable time duration, or by providing a threshold representing a certain amount of call signals. If the time or the amount of call signal provided by the threshold is reached, the microprocessor 26 is activating the transmitting unit 27b such that the selected message Sᵣ is transmitted back to the user terminal 10 of the calling party.

It should be obvious for a person skilled in the art that the receiving unit 27a and the transmitting unit 27b also can be incorporated within one so called transceiver unit.

Moreover, the invention is covering embodiments wherein the messages to be directed can be optical and/or acoustical replayed at the receiving side, i.e. based on the exemplar embodiment at the user terminal 10. It is further proposed that the user terminal 20 is adapted to use the so called wireless access protocol which also can be used for generating reply signals based on an information fetched from the internet. Furthermore, as an alternative or in addition to the key board 22 the user terminal 20 including the automatic information reply functionality may be speech operated, too.

What is claimed:

1. A method for automatically transmitting an information reply signal between a user terminal of a called party of a telecommunication system, in particular of a mobile radio telecommunication system, and a user terminal of a calling party of a telecommunication system, in particular of a mobile radio telecommunication system, wherein the information reply signal is transmitted from the user terminal of the called party to the user terminal of the calling party in response to an incoming call originated by said calling party.

2. A method of claim 1,
wherein the information reply signal is generated for optical and/or acoustical replying.

3. A method of claim 1,
wherein the information reply signal is generated by means of a short message service.

4. A method of claim 1,
wherein the information reply signal is generated individually and is stored in the user terminal of the called party.

5. A method of claim 1,
wherein a plurality of information reply signals are generated and stored with each of the information reply signals assigned to at least one definable number of stored potential calling parties.

6. A method of claim 1,
wherein a plurality of information reply signals are generated and stored, with each of the information reply signals assigned to a specific day time.

7. A method of claim 1,
wherein the information reply signal is transmitted after a definable amount of ringing signals based on the incoming call and/or after a definable duration of time based on the time of incoming.

8. A user terminal of a telecommunication system,
in particular a mobile station of a mobile radio telecommunication system, the user terminal having means for transmitting an information reply signal to the user terminal of a calling party of a telecommunication system in response to an incoming call originated by said calling party.

9. A user terminal of claim 8,
comprising means for generating the information reply signal by use of a short message service, by use of a wireless access protocol and/or means for generating the information reply signals by use of speech controlling.

10. A user terminal of claim 8,
comprising means for generating at least one individual information reply signal.

11. A user terminal of claim 10,
wherein the means comprises a micro processor and/or an implemented software.

12. A user terminal of claim 8,
comprising means for assigning an information reply signal to an individual phone number of an user terminal of a party.

13. A user terminal of claim 8,
comprising means for assigning an information reply signal to a specific day time.

14. A user terminal of claim 8,
comprising means for optionally activating the means for transmitting.

15. A user terminal of claim 8,
comprising means for controlling a threshold representing the time between a first ringing signal of the incoming call and the activating of the means for transmitting.

16. A telecommunication system comprising a user terminal of claim 8.
